(19) United States
(12) Patent Application Publication
(10) Pub. No.: US 2007/0241139 A1
(43) Pub. Date: Oct. 18, 2007

(54) Liquid spray dispenser with flexible tube guide

(76) Inventor: Edward Shade, Cockeysville, MD (US)

Correspondence Address: JAMES RAY & ASSOCIATES, 2640 PITCAIRN ROAD, MONROEVILLE, PA, 15146, US

(21) Appl. No.: 11/787,809

(22) Filed: Apr. 18, 2007

Related U.S. Application Data
(60) Provisional application No. 60/792,772, filed on Apr. 18, 2006.

(51) Int. Cl. B67D 5/60

(52) U.S. Cl. 222/464.7

(57) ABSTRACT

The present invention comprises a liquid spray dispenser with a container, spray rotatably attached to the container and flexible tube attached at a closed end to the sprayer and an open end. The container has a partition that forms an upper and lower reservoir and a guide integral to the container. The guide positions the flexible tube so that the open end of the flexible tube is within the lower reservoir. Reservoir fills with liquid in the vertical position and retains fluid in the transverse or inverted position so that the flexible tube remains in liquid communication the lower reservoir so that the sprayer does not lose its prime in the transverse or inverted position.

### CROSS REFERENCE TO RELATED APPLICATION

This patent application is related to and claims priority from U.S. Provisional Patent Application Ser. No. 60/792,772 filed Apr. 18. 2006.

### FIELD OF THE INVENTION

The present invention relates, in general, to liquid spray dispensers and, more particularly, this invention relates to dispensers that can be operated in a non-vertical position.

### BACKGROUND OF THE INVENTION

Prior to the conception and development of the present invention, as is generally well known in the prior art, liquid spay dispensers that operate in the vertical position.

When operated in the transverse or inverted position the conventional liquid spray dispenser loses its prime causing the loss of fluid for the sprayer. The requirement to return the dispenser to the vertical position is inconvenient and reestablishing the prime is wasteful. This limitation made the use of such dispensers awkward to use in close spaces and useless in many situations.

Several solutions to this limitation have been proposed. The use of a separate reservoir within the dispenser to retain liquid so as to retain the charge is well known. However, some liquid dispensers with a separate reservoir required that the container be held at angle to fill the reservoir. This arrangement was required because of the problem of guiding the dispenser's flexible tube. The curved partition guided the placement of the flexible tube. Other liquid dispensers with a separate reservoir require the placement of a second partition to guide the placement of the flexible tube. This allows the reservoir to be filled in the upright position, but adds to the cost and complexity to the manufacture of the dispenser.

### SUMMARY OF THE INVENTION

The present invention provides container with a base, sidewalls and a neck. A partition is adjacent to the sidewalls on three edges. The partition forms an upper and lower reservoir in the liquid dispenser. The lower reservoir fills in the upright position as liquid flows from the upper reservoir to the lower reservoir. The sprayer assembly includes a cap and a sprayer is attached to the neck of the container. The sprayer can rotate at least 180 degrees. The flexible tube has a closed end that is attached that is attached to the sprayer and an open end that is proximate to a sidewall perpendicular to the horizontal axis of the container in the lower reservoir. The flexible tube is positioned by a guide surface that is formed in the side wall of the dispenser and is integral in that side wall. The guide is an undulating surface that has at least one concave surface located between at least two convex surfaces. The flexible tube is accommodated by the concave surface and placed in the lower reservoir. In the substantially transverse and substantially inverted position the lower reservoir retains liquid. The sprayer rotates 180 degrees so that the dispenser in the substantially transverse and inverted position retains liquid and the sprayer does not lose its prime.

Another embodiment of the present invention the partition is curved downward forming a lip to retain more liquid in the invert position.

Another embodiment of the present invention the guide is a portion of a sidewall that is perpendicular to the horizontal axis of the container. The portion of the sidewall in the lower reservoir is angled so as to deflect the flexible tube into position so that the open end of the flexible tube is proximate to the other sidewall that is perpendicular to the horizontal axis of the container.

Another embodiment of the present invention is an elongated base and the sidewall is forms a curve so that the side wall that is substantially vertical at its juncture with the base forms a substantially horizontal surface which forms a lower reservoir and then is further curve so that the uppers portion of the sidewall is substantially vertical.

### OBJECTS OF THE INVENTION

It is, therefore, one of the primary objects of the present invention to provide liquid spray dispenser that can operate in the vertical, transverse and inverted positions without the loss of the prime to the sprayer.

Another object of the present invention is to provide to provide a simplified guide for the flexible tube of the liquid dispenser.

An additional object of the present invention is to provide a flexible tube guide that does not require an additional guide structure.

Still another object of the present invention is to provide a flexible tube guide that is integral to the container.

Still another object of the present invention is to provide a rotatable sprayer so that the dispenser can be used to spray the underside of surfaces without losing a prime or repositioning the dispenser

Still another object of the present invention is to provide for the filling of the reservoir in the vertical position for use in the transverse or inverted position without repositioning the liquid spray dispenser.

Yet another object of the present invention is to provide for the filling of the reservoir by gravity.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended

### BRIEF DESCRIPTION OF THE DRAWINGS

FIG. 1 is a side view of the dispenser in the vertical position;

FIG. 2 is a cross section view of a portion of the dispenser in the vertical axis of the flexible tube guide;

FIG. 3 is a side view of the dispenser in the transverse position; and

FIG. 4 is a side view of another embodiment of the dispenser.

### BRIEF DESCRIPTION OF A PRESENTLY PREFERRED AND VARIOUS

### ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

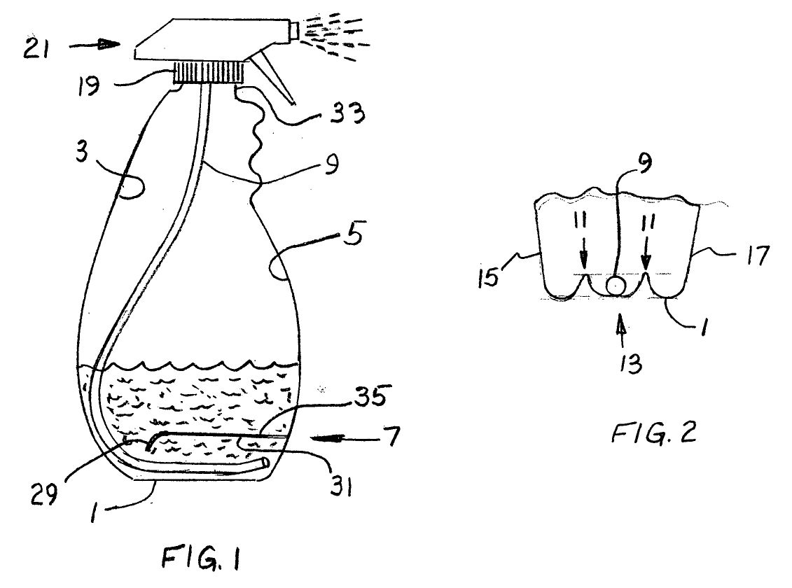

Reference is now made, more particularly, to FIGS. 1 and 2 which shows a liquid spray dispenser with a base 1, first sidewall 15 and second sidewall 17 which are perpendicular to the horizontal axis and third sidewall 3 and fourth sidewall 5 along the horizontal axis of the dispenser and a neck 10. The dispenser has a partition 7. The partition is impermeable and is adjacent to the side walls of the dispenser along 3 edges. A fourth edge is open. The open edge 29 has a slope towards the base 1 forming a lip. The base 1, side walls 3, 5, 15 and 17 and lower surface 31 of the partition, form the lower reservoir. The upper reservoir is formed by the upper surface 35 of the partition and the container's sidewalls 3, 5, 15 and 17. The lower reservoir fills with fluid from the upper reservoir by gravity in the substantially upright position. A sprayer 21 is attached by a cap 19 to dispenser neck 33. The sprayer can rotate about the vertical axis at least 180 degrees. Attached to the sprayer 21 is the closed end of flexible tube 9. Flexible tube 9 is inserted into the dispenser and guided into position so that its open end is proximate to side wall 5. The guide is shown in more detail in FIG. 2.

In FIG. 2, the preferred embodiment, the guide is formed in sidewall 3. The surface of sidewall 3 is undulating with at least one convex surface between 2 concave surfaces. The flexible tube 9 is accommodated by the convex surface and guided on insertion so that the open end of flexible tube 9 is proximate to sidewall 5.

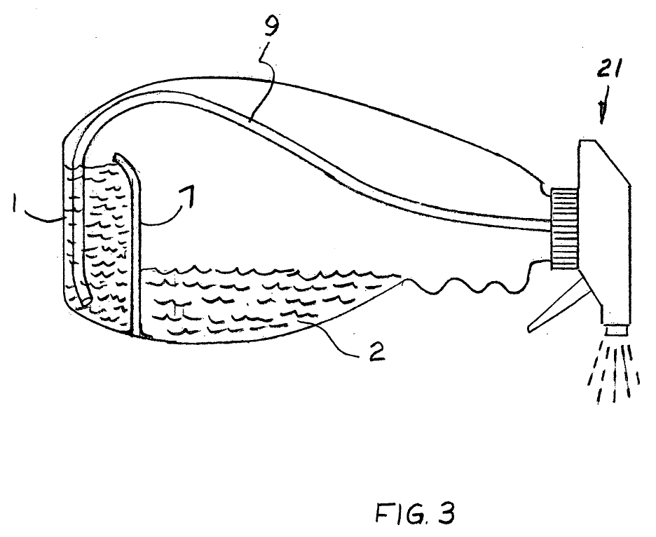

In FIG. 3 the dispenser is shown in the transverse position with the fluid retained in the lower reservoir formed by the base 1, lower surface 33 of partition 7, and the side walls 5, 15 and 17. Similarly, the dispenser operates in the substantially inverted position with sprayer 21 rotated 180 degrees.

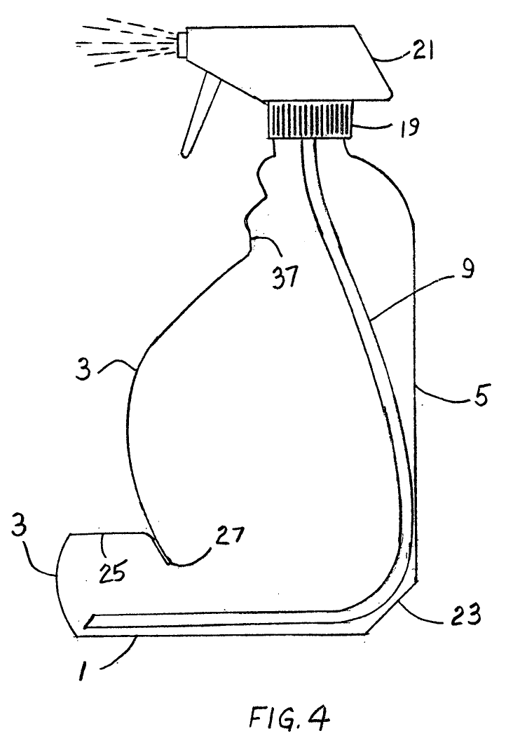

In FIG. 4 another embodiment of the dispenser is show in which the guide is an angled surface 23 in the lower portion of sidewall 3 which deflects the flexible tube 9 so that the open end of flexible tube 9 is substantially proximate with side wall 5.

Also, in FIG. 4, another embodiment of the dispenser is show where the base 1 is elongated and the lower reservoir is formed by the curved surface of sidewall 5. The lower sidewall portion 39 of sidewall 5 beginning at the corner with base 1 is substantially parallel to the vertical axis of the dispenser. Sidewall 5 is curved so that it forms a surface substantially perpendicular to the vertical axis 25. The substantially perpendicular surface 25 is bend 27 is formed approximating a hypocycloid in side view. The upper portion of sidewall 5 between angle 27 and neck 33 is curved from the substantially perpendicular to the vertical axis surface to the substantially parallel to the vertical axis surface 37. The base 1, the substantially perpendicular surface to the vertical axis of sidewall 5, side wall 2, side wall 3 and substantially perpendicular surface 25 form the lower reservoir. Liquid can flow by gravity into the lower reservoir in the vertical position. FIG. 4 also shows the sprayer in the 180 degree rotated position.

The embodiment in FIG. 4 can also utilize the integral guide shown in FIG. 2.

The embodiment in FIG. 1 can also utilize the guide show in FIG. 4.

The embodiment in FIG. 4 can also operate in the transverse and inverted position as previously described and shown in FIG. 3

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A spray liquid dispenser comprising:
(a) a liquid container having a substantially vertical and horizontal axis, and a neck; an interior surface of said liquid container with a base, first sidewall, second sidewall, third sidewall and fourth sidewall with said first and second sidewalls disposed substantially along said horizontal axis and said third and fourth sidewalls disposed substantially perpendicular to said horizontal axis; (b) an impermeable partition of predetermined length and width, said partition having an upper and lower surface with three adjacent edges and an open edge with said partitions adjacent edges adjacent to said interior surface of said liquid container along the first, second and third sidewalls forming a lower and upper reservoir creating an opening so as to permit the communication of liquid between said reservoirs; (c) a sprayer rotatably attached to said neck of said liquid container so that said sprayer can be rotated at least 180 degrees; (d) a flexible tube of predetermined length having a closed end attached to said sprayer and an open end disposed in said lower reservoir so that said flexible tube communicates with said fluid in said lower reservoir; a guiding means integral to said fourth sidewall to insert said flexible tube so that the open end of said flexible tube is substantially proximate to the third sidewall.

2. An apparatus according to claim 1 where said guiding means consists of at least one interior undulating surface within said fourth sidewall of said container with at least two convex surfaces with a concave surface between said convex surfaces; said convex surface having predetermined width to accommodate said flexible tube.

3. An apparatus according to claim 1 where said guiding means is a portion of said third sidewall within said lower reservoir is formed at a predetermined angle from the vertical axis to deflect the flexible tube into position.

4. An apparatus according to claim 1 where said guiding means is a third or fourth sidewall is curved so as to deflect said flexible tube relative to the base.

5. An apparatus according to claim 1 in which said interior partition open edge has curvature toward said base forming a lip upon said open edge.

6. An apparatus according to claim 1 in which the open end of said flexible tube is proximate to the corner of said third sidewall and said lower member surface.

7. In a spray liquid dispenser comprising:
(a) a liquid container having a substantially vertical and horizontal axis, and a neck, an interior surface of said liquid container with a base elongated along the horizontal axis, first sidewall, second sidewall, third sidewall and fourth sidewall with said first and second sidewalls disposed substantially along said horizontal axis and said third and fourth sidewalls disposed substantially perpendicular to said horizontal axis, said fourth sidewall has a lower portion beginning at the corner with said base that is substantially parallel to said vertical axis a curve that forms a surface substantially perpendicular to said vertical axis and and upper portion of said fourth side wall formed by bend in said substantially perpendicular surface to said vertical axis to said neck forming a lower reservoir of said lower portion of said fourth sidewall, said first sidewall, said second sidewall and said substantially perpendicular surface to said vertical axis and an upper reservoir formed by said upper portion of said fourth sidewall, said first sidewall and said second sidewall so as to permit the communication of liquid between said upper reservoir and said lower reservoir; (b) a sprayer assembly with a cap and sprayer rotatably attached to said neck of said liquid container so that said sprayer can be rotated at least 180 degrees; (c) a flexible tube of predetermined length having a closed end attached to said sprayer and an open end disposed in said lower reservoir so that said flexible tube communicates with said fluid in said lower reservoir; (d) a guiding means integral to said fourth sidewall to insert said flexible tube so that the open end of said flexible tube is substantially proximate to the third sidewall.

8. An apparatus according to claim 7 where said guiding means consists of at least one interior undulating surface within said fourth sidewall of said container with at least two convex surfaces with a concave surface between said convex surfaces; said convex surface having predetermined width to accommodate said flexible tube.

9. An apparatus according to claim 7 where said guiding means is a portion of said third sidewall within said lower reservoir is formed at a predetermined angle from the vertical axis to deflect the flexible tube into position.

10. An apparatus described in claim 7 where said guiding means is a third sidewall is curved so as to deflect said flexible tube relative to the base.

11. An apparatus described in claim 7 where said upper surface of said lower reservoir is concave.

12. An apparatus described in claim 7 in which the lower fourth sidewall is concave.
